(19) United States
(12) Patent Application Publication
(10) Pub. No.: US 2026/0153783 A1
(43) Pub. Date: Jun. 4, 2026

(54) REFLECTION MODULE AND CAMERA MODULE INCLUDING THE SAME

(71) Applicant: SAMSUNG ELECTRO-MECHANICS CO., LTD., Suwon-si (KR)

(72) Inventors: Bo Sung SEO, Suwon-si (KR); Young Hwan KWON, Suwon-si (KR)

(73) Assignee: SAMSUNG ELECTRO-MECHANICS CO., LTD., Suwon-si (KR)

(21) Appl. No.: 19/388,253

(22) Filed: Nov. 13, 2025

(30) Foreign Application Priority Data
Nov. 29, 2024 (KR) 10-2024-0175214
Sep. 18, 2025 (KR) 10-2025-0134556

(51) Int. Cl. G03B 5/00

(52) U.S. Cl. CPC G03B 5/00; G03B 2205/0007; G03B 2205/0069

(57) ABSTRACT

A reflection module includes a housing, a guide member configured to be rotatable relative to the housing about a first rotational axis, a holder configured to be rotatable about a second rotational axis, relative to the guide member and having a reflection member mounted thereon, and a first driver including a first driving magnet disposed on the holder and a first coil facing the first driving magnet, a pulling yoke disposed on the guide member and facing the first driving magnet, wherein the first driving magnet includes two magnets, the two magnets being separately disposed on one side surface and another side surface of the holder, spaced apart in a direction of the second rotational axis.

### CROSS-REFERENCE TO RELATED APPLICATIONS

This application claims the benefit under 35 USC 119(a) of Korean Patent Application No. 10-2024-0175214 filed on Nov. 29, 2024, and Korean Patent Application No. 10-2025-0134556 filed on Sep. 18, 2025, in the Korean Intellectual Property Office, the entire disclosures of which are incorporated herein by reference for all purposes.

### BACKGROUND

### 1. Field

The present disclosure relates to a reflection module and a camera module including the same.

### 2. Description of the Background

Recently, a camera module in which a reflection member is disposed in front of a lens module to bend a propagation path of light has been adopted in mobile devices.

Furthermore, the camera module may have a shake correction function compensating for shaking during image capturing to improve a degree of resolution. The shake correction function may be implemented through two-axis rotation of the reflection member.

However, since the reflection member may be disposed to be rotatable, there may be a problem in that the reflection member may tilt to one side when the camera module is powered off.

Furthermore, the two-axis rotation of the reflection member may require a plurality of drivers, but since structures of the plurality of drivers are complex, there may be problems that a size and weight thereof may increase.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, reflection module includes a housing, a guide member configured to be rotatable relative to the housing about a first rotational axis, a holder configured to be rotatable about a second rotational axis, relative to the guide member and having a reflection member mounted thereon, and a first driver including a first driving magnet disposed on the holder and a first coil facing the first driving magnet, a pulling yoke disposed on the guide member and facing the first driving magnet, wherein the first driving magnet includes two magnets, the two magnets being separately disposed on one side surface and the other side surface of the holder, spaced apart in a direction of the second rotational axis.

Directions in which the first driving magnet and the first coil face each other may be perpendicular to directions in which the first driving magnet and the pulling yoke face each other.

The first driving magnet and the first coil may face each other in the direction of the second rotational axis, and the first driving magnet and the pulling yoke may face each other in a direction of the first rotational axis.

The reflection module may further include a protrusion protruded in a direction, perpendicular to both the first and second rotational axes, disposed on the housing, wherein a first ball member may be disposed between the protrusion and the guide member.

The reflection module may further include a first magnetic portion disposed on the protrusion, and a second magnetic portion facing the first magnetic portion disposed on the guide member, wherein both attractive and repulsive forces may be applied between the first magnetic portion and the second magnetic portion.

A region in which the attractive force acts may be closer to the first ball member than a region in which the repulsive force acts.

The first magnetic portion may include a first magnet and a second magnet, spaced apart in the direction of the second rotational axis, the second magnetic portion may include a third magnet and a fourth magnet, spaced apart in the direction of the second rotational axis, and the first ball member may be disposed between the first magnet and the second magnet and between the third magnet and the fourth magnet.

One surface of the first magnet and one surface of the third magnet may face each other in the direction perpendicular to both the first and second rotational axes, one surface of the second magnet and one surface of the fourth magnet may face each other in the direction perpendicular to both the first and second rotational axes, the number of polarities on the one surface of the first magnet may be different from the number of polarities on the one surface of the third magnet, and the number of polarities on the one surface of the second magnet may be different from the number of polarities on the one surface of the fourth magnet.

The protrusion may include an inclined surface, wherein the inclined surface may be formed to be inclined from a surface on which the first ball member is disposed, in the direction of the second rotational axis, and the first magnet and the second magnet may be respectively disposed on the inclined surface.

A distance between the first magnetic portion and the second magnetic portion may increase in a direction away from the first ball member.

The reflection module may further include a second ball member disposed between the guide member and the holder, the second ball member may include a plurality of balls spaced apart in the direction of the second rotational axis, a plurality of guide grooves into which the second ball members are disposed may be formed in the guide member, and the pulling yoke may be disposed in the plurality of guide grooves.

The second ball member may be in contact with the pulling yoke.

The reflection module may further include a first sub-position sensor configured to sense a position of one magnet among the two magnets, and a second sub-position sensor configured to sense a position of another magnet among the two magnets.

Polarity arrangement forms of the two magnets may be identical, a position of the reflection member relative to rotation about the second rotational axis may be detected by performing a sum operation on signal values output from the first sub-position sensor and the second sub-position sensor, and a position of the reflection member relative to rotation about the first rotational axis may be detected by performing a difference operation on signal values output from the first sub-position sensor and the second sub-position sensor.

A camera module may include the reflection module, and a case coupled to the housing and having an opening through which light passes, wherein the reflection member may have an incident surface on which the light is incident, and the incident surface may have a convex shape.

The camera module may further include a cover coupled to the opening, wherein a through-hole may be formed in the cover through which the light passes, and the through-hole may have two straight sections and two curved sections.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of a camera module according to an embodiment of the present disclosure.

FIG. 3 is an exploded perspective view of a portion of a reflection module and a housing.

FIG. 4 is a plan view of a protrusion of a housing.

FIG. 5 is a bottom view of a guide member and a holder of a reflection module.

FIGS. 6 and 7 are views illustrating attractive and repulsive forces acting between first and second magnetic portions.

FIG. 8 is an exploded perspective view of a reflection module.

FIG. 9 is a view illustrating a positional relationship between a first driver, a first ball member, and a second ball member.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An object of an embodiment of the present disclosure is to provide a reflection module capable of simplifying a structure thereof, and a camera module including the same.

The present disclosure relates to a reflection module and a camera module including the same. The camera module may be mounted on a portable electronic device such as a mobile communication terminal, a smartphone, a tablet PC, or the like.

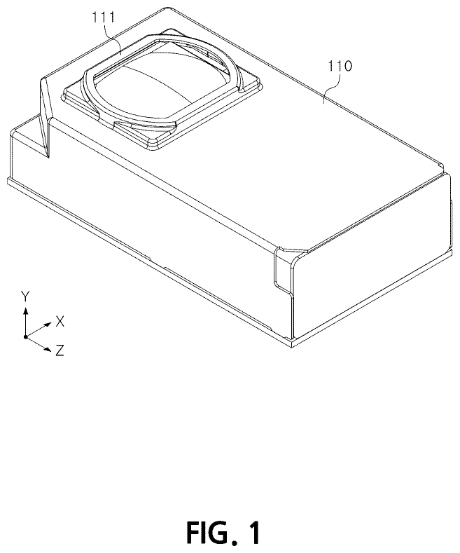

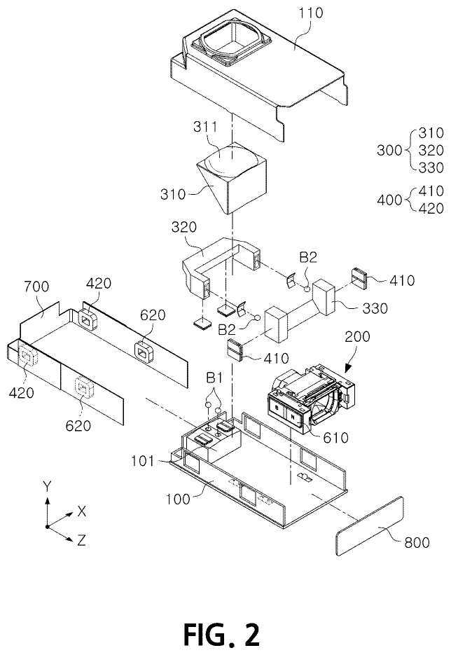

FIG. 1 is a perspective view of a camera module according to an embodiment of the present disclosure, and FIG. 2 is an exploded perspective view of a camera module according to an embodiment of the present disclosure.

Referring to FIGS. 1 and 2, a camera module according to an embodiment of the present disclosure may include a reflection module 300 and a housing 100.

The reflection module 300 may be located in the housing 100, and may include a reflection member 310 having a reflective surface.

The reflection member 310 may be disposed to rotate around two different axes for shake correction. For example, the reflection member 310 may rotate around two axes, perpendicular to each other, in the housing 100.

In an embodiment, the reflection module 300 may further include a first lens module 311.

The first lens module 311 may include at least one lens, and the at least one lens may have a first optical axis (Y-axis). The first optical axis (Y-axis) may extend in a vertical direction with respect to FIG. 2. The first optical axis (Y-axis) may pass through a center of the at least one lens of the first lens module 311.

The first lens module 311 may be disposed in the reflection member 310. In an embodiment, the first lens module 311 may be formed on an incident surface of the reflection member 310. For example, the incident surface of the reflection member 310 may have a convex shape, and may thus have refractive power. In this case, the incident surface of the reflection member 310 may function as the first lens module 311.

In an embodiment, the camera module may further include a second lens module 200. The second lens module 200 may be disposed between the reflection module 300 and an image sensor 800. The second lens module 200 may include a plurality of lenses, and may have a second optical axis (Z-axis). The plurality of lenses may be disposed along the second optical axis (Z-axis). The second optical axis (Z-axis) may pass through a center of the plurality of lenses of the second lens module 200.

The first optical axis (Y-axis) of the first lens module 311 and the second optical axis (Z-axis) of the second lens module 200 may be disposed to be perpendicular to each other.

At least one lens among the plurality of lenses of the second lens module 200 may be non-circular when viewed in a second optical axis (Z-axis) direction. For example, a non-circular lens may have different lengths in two directions, perpendicular to the second optical axis (Z-axis) direction and perpendicular to each other. In an embodiment, the non-circular lens may have a length in a first axis (X-axis) direction, perpendicular to both the first optical axis (Y-axis) direction and a second optical axis (Z-axis) direction, longer than a length in the first optical axis (Y-axis) direction.

The first lens module 311 and the reflection member 310 may be configured to rotate together for shake correction. The second lens module 200 may move along the second optical axis (Z-axis) direction for focus adjustment.

The camera module may further include an image sensor 800.

The image sensor 800 may have an imaging surface, and light passing through the second lens module 200 may be received on the imaging surface.

The camera module may further include a case 110. The case 110 may be coupled to the housing 100 to cover an upper portion of the housing 100. The case 110 may have an opening, through which light is incident on the first lens module 311.

A cover 111 may be coupled to the opening of the case 110. The cover 111 may be coupled to a periphery of the opening of the case 110. The cover 111 may have a through-hole to allow light to be incident into the camera module. The through-hole of the cover 111 may have a track shape having a straight portion and a curved portion. For example, the through-hole of the cover 111 may be formed to have two straight sections and two curved sections (e.g., a semicircular curved section).

A stepped portion may be formed on at least one of corners of the case 110 adjacent to the cover 111. For example, referring to FIG. 1, one of two corners of the case 110 adjacent to the cover 111 may include a stepped portion.

The stepped portion may be formed stepwise on an upper surface of the case 110.

Additionally, a stepped portion may be formed at a corner of the housing 100 corresponding to one corner of the case 110.

Therefore, a thickness of one corner of the case 110 (thickness in the first optical axis (Y-axis) direction) may be formed to be thinner than other portions. Therefore, space utilization of a region in which the camera module is mounted in a portable electronic device may be improved.

Although the present embodiment describes the reflection module 300 and the housing 100 as separate components, the housing 100 may also be provided as a component included in the reflection module 300.

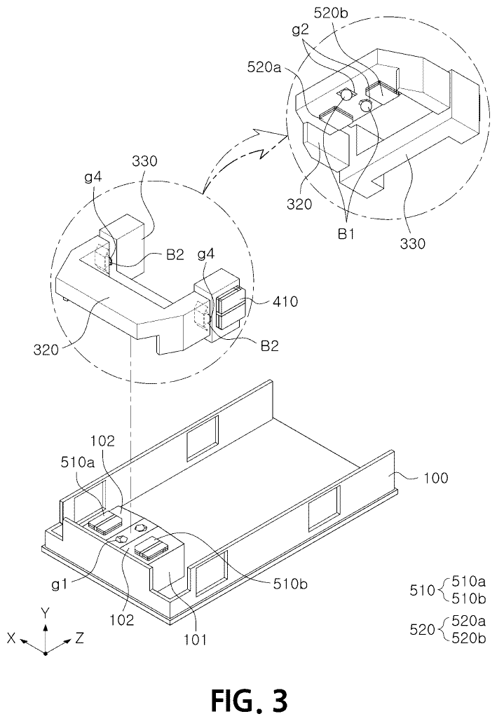

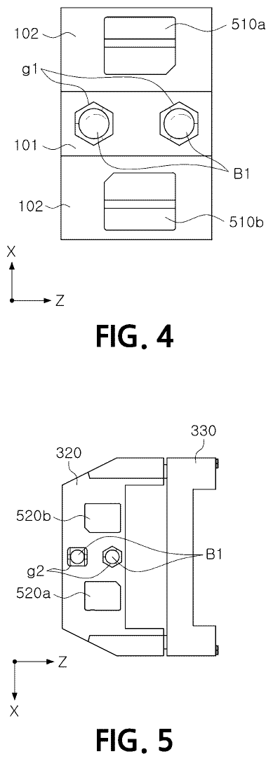

FIG. 3 is an exploded perspective view of a portion of a reflection module and a housing, FIG. 4 is a plan view of a protrusion of a housing, and FIG. 5 is a bottom view of a guide member and a holder of a reflection module.

Referring to FIGS. 3 and 5, a reflection module 300 may include a holder 330 and a guide member 320. The reflection module 300 may further include a reflection member 310 coupled to the holder 330.

The reflection member 310 may have a reflective surface reflecting light. For example, the reflection member 310 may be a prism or a mirror.

When the reflection member 310 is the prism, the reflection member 310 may have any shape obtained by diagonally dividing a rectangular parallelepiped (or a cube) into two equal portions. The prism may include an incident surface through which light enters, a reflective surface reflecting light passing through the incident surface, and an exit surface through which light reflected from the reflective surface exits. The incident surface may have a convex shape, and the convex shape of the incident surface may function as a first lens module 311.

The reflection member 310 may be mounted on the holder 330.

The holder 330 may be rotatably located on the guide member 320. The guide member 320 may be rotatably disposed in a housing 100.

The guide member 320 may rotate around a second optical axis (Z-axis) as a rotational axis. For example, the guide member 320 may rotate relative to the housing 100 around the second optical axis (Z-axis). In this case, the holder 330 may also be rotated together with the guide member 320. The second optical axis (Z-axis) may also be referred to as a first rotational axis.

For convenience of explanation, it has been described that the guide member 320 rotates around the second optical axis (Z-axis) as the rotational axis. However, the rotational axis of the guide member 320 may not be completely identical to the second optical axis (Z-axis). For example, the rotational axis of the guide member 320 may be defined by a first ball member B1 to be described below.

The holder 330 may rotate around a first axis (X-axis), perpendicular to both a first optical axis (Y-axis) and the second optical axis (Z-axis). For example, the holder 330 may rotate relative to the guide member 320 around the first axis (X-axis). The first axis (X-axis) may also be referred to as a second rotational axis.

For convenience of explanation, it has been described that the holder 330 rotates around the first axis (X-axis) as a rotational axis, but the rotational axis of the holder 330 may not be completely identical to the first axis (X-axis). For example, the rotational axis of the holder 330 may be defined by a second ball member B2 to be described below.

Since the reflection member 310 may be mounted on the holder 330, the reflection member 310 and the holder 330 may rotate together.

A first driver 400 may be provided to rotate the reflection module 300. The first driver 400 may include a first driving magnet 410 and a first coil 420. The guide member 320 may rotate relative to the housing 100 with respect to the second optical axis (Z-axis) by the first driver 400. Since the holder 330 may be disposed on the guide member 320, the holder 330 may also be rotated together with the guide member 320.

The first driving magnet 410 may be mounted on the holder 330. For example, the first driving magnet 410 may be mounted on a side surface of the holder 330. The side surface of the holder 330 may refer to a surface of the holder 330 facing the housing 100 in a first axis (X-axis) direction.

The first driving magnet 410 may be magnetized such that one surface (e.g., a surface facing the first coil 420) has both an N-pole and an S-pole. In an embodiment, a surface of the first driving magnet 410 facing the first coil 420 may be sequentially provided with an N-pole, a neutral region, and an S-pole in a first optical axis (Y-axis) direction.

The first coil 420 may be disposed in a position facing the first driving magnet 410. In an embodiment, the first coil 420 may be disposed to face the first driving magnet 410 in the first axis (X-axis) direction.

The first coil 420 may be disposed on a substrate 700, and the substrate 700 may be mounted on the housing 100 such that the first driving magnet 410 and the first coil 420 face each other in the first axis (X-axis) direction.

The housing 100 may be provided with a through-hole penetrating the housing 100 in the first axis (X-axis) direction, and the first coil 420 may be disposed in the through-hole to directly face the first driving magnet 410.

During shake correction, the first driving magnet 410 may be a movable member mounted on the holder 330 and rotating, and the first coil 420 may be a fixed member fixed to the substrate 700.

When power is applied to the first driver 400, the first driver 400 may generate a driving force necessary for rotation of the guide member 320 and the holder 330 about the second optical axis (Z-axis). For example, the first driver 400 may generate a driving force in the first optical axis (Y-axis) direction.

The first driving magnet 410 may include a plurality of magnets. In an embodiment, the first driving magnet 410 may include two magnets spaced apart from each other. The two magnets of the first driving magnet 410 may be spaced apart in the first axis (X-axis) direction.

One of the two magnets of the first driving magnet 410 may be disposed on one side surface of the holder 330, and the other of the two magnets of the first driving magnet 410 may be disposed on the other side surface of the holder 330. The one side surface of the holder 330 and the other side surface of the holder 330 may be spaced apart from each other in the first axis (X-axis) direction.

The first coil 420 may include a plurality of coils. In an embodiment, the first coil 420 may include two coils spaced apart from each other. The two coils of the first coil 420 may be spaced apart from each other in the first axis (X-axis) direction.

In an embodiment, one pair of magnet and coil may be disposed on one side of the reflection module 300, and the other pair of magnet and coil may be disposed on the other side of the reflection module 300.

In an embodiment, when the guide member 320 and the holder 330 rotate around the second optical axis (Z-axis) as a rotational axis, a direction of a driving force of the one pair of magnet and coil may be opposite to a direction of a driving force of the other pair of magnet and coil.

For example, when the direction of the driving force of the one pair of magnet and coil is in a positive first optical axis (Y-axis) direction (+Y-axis direction) and the direction of the driving force of the other pair of magnet and coil is in a negative first optical axis (Y-axis) direction (−Y-axis direction), the guide member 320 and the holder 330 may rotate around the second optical axis (Z-axis).

In addition, when the direction of the driving force of the one pair of magnet and coil is in a negative first optical axis (Y-axis) direction (−Y-axis direction) and the direction of the driving force of the other pair of magnet and coil is in a positive first optical axis (Y-axis) direction (+Y-axis direction), the guide member 320 and the holder 330 may rotate with respect to the second optical axis (Z-axis).

The first ball member B1 may be disposed between the guide member 320 and the housing 100. The first ball member B1 may be disposed between the guide member 320 and the housing 100 to form a rotational axis of the guide member 320.

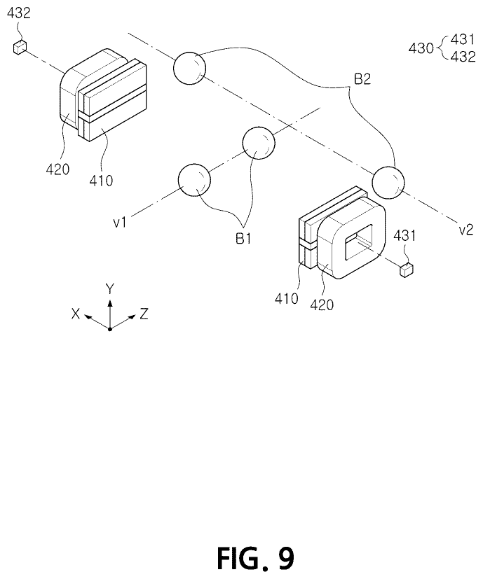

The first ball member B1 may include a plurality of balls spaced apart in the second optical axis (Z-axis) direction. A virtual line v1 connecting the plurality of balls of the first ball member B1 in the second optical axis (Z-axis) direction may be spaced apart from the first driving magnet 410 in the first axis (X-axis) direction (see FIG. 9).

In an embodiment, the first driving magnet 410 and the first coil 420 may be spaced apart from the first ball member B1 in the first axis (X-axis) direction. When a driving force is generated in the first optical axis (Y-axis) direction by the first driving magnet 410 and the first coil 420, the guide member 320 may rotate around a rotational axis formed by the first ball member B1.

The virtual line v1 connecting the plurality of balls of the first ball member B1 in the second optical axis (Z-axis) direction may pass through a reflective surface of the reflection member 310.

In an embodiment, when viewed in the first axis (X-axis) direction, a line extending from the second optical axis (Z-axis) of the second lens module 200 may be located between both ends of the plurality of balls of the first ball member B1. In this case, the both ends of the plurality of balls of the first ball member B1 may refer to both ends in the first optical axis (Y-axis) direction.

A first guide groove g1 and a second guide groove g2 may be disposed on surfaces in which the guide member 320 and the housing 100 face each other (for example, surfaces facing each other in the first optical axis (Y-axis) direction). For example, the first guide groove g1 may be disposed on the housing 100, and the second guide groove g2 may be disposed in the guide member 320. The first guide groove g1 and the second guide groove g2 may face each other in the first optical axis (Y-axis) direction.

The first guide groove g1 may include a plurality of grooves spaced apart in the second optical axis (Z-axis) direction, and the second guide groove g2 may include a plurality of grooves spaced apart in the second optical axis (Z-axis) direction.

The first ball member B1 may be disposed between the first guide groove g1 and the second guide groove g2 to form a rotational axis of the guide member 320.

Any one of the plurality of grooves of the second guide groove g2 may be in three-point contact with the first ball member B1, and another one of the plurality of grooves of the second guide groove g2 may be in two-point contact with the first ball member B1. For example, referring to FIG. 5, a groove located on the right side of the plurality of grooves of the second guide groove g2 may be in three-point contact with the first ball member B1, and a groove located on the left side of the plurality of grooves of the second guide groove g2 may be in two-point contact with the first ball member B1.

In addition, each of the plurality of grooves of the first guide groove g1 may be in three-point contact with the first ball member B1. A shape of the first guide groove g1 may be also opposite to a shape of the second guide groove g2.

In an embodiment, a protrusion 101 may be disposed on an inner bottom surface of the housing 100. The protrusion 101 may have a shape protruding and extending from the inner bottom surface of the housing 100 in the first optical axis (Y-axis) direction.

The first guide groove g1 may be formed on one surface of the protrusion 101 (e.g., a surface facing the guide member 320 in the first optical axis (Y-axis) direction).

A magnetic force may be applied between the guide member 320 and the housing 100. For example, a first magnetic portion 510 may be disposed on one of the guide member 320 or the housing 100, and a second magnetic portion 520 may be disposed on the other thereof.

In an embodiment, the first magnetic portion 510 may be disposed on the housing 100, and the second magnetic portion 520 may be disposed on the guide member 320.

The first magnetic portion 510 and the second magnetic portion 520 may face each other in the first optical axis (Y-axis) direction.

In an embodiment, the first magnetic portion 510 may be disposed on an upper surface of the protrusion 101 of the housing 100, and the second magnetic portion 520 may be disposed on a lower surface of the guide member 320.

The first magnetic portion 510 may include a plurality of magnets spaced apart in the first axis (X-axis) direction. In an embodiment, the first magnetic portion 510 may include a first magnet 510a and a second magnet 510b. The first magnet 510a and the second magnet 510b may be spaced apart in the first axis (X-axis) direction.

The first guide groove g1 may be located between the first magnet 510a and the second magnet 510b.

The second magnetic portion 520 may include a plurality of magnets spaced apart in the first axis (X-axis) direction. In an embodiment, the second magnetic portion 520 may include a third magnet 520a and a fourth magnet 520b. The third magnet 520a and the fourth magnet 520b may be spaced apart in the first axis (X-axis) direction.

The second guide groove g2 may be located between the third magnet 520a and the fourth magnet 520b.

The first driver 400 may rotate the guide member 320 and the holder 330 around the second optical axis (Z-axis). For example, the guide member 320 and the holder 330 may rotate around the second optical axis (Z-axis) by the first driver 400.

When the guide member 320 rotates around the second optical axis (Z-axis), the second magnetic portion 520 coupled to the guide member 320 may be a movable member, and the first magnetic portion 510 coupled to the housing 100 may be a fixed member.

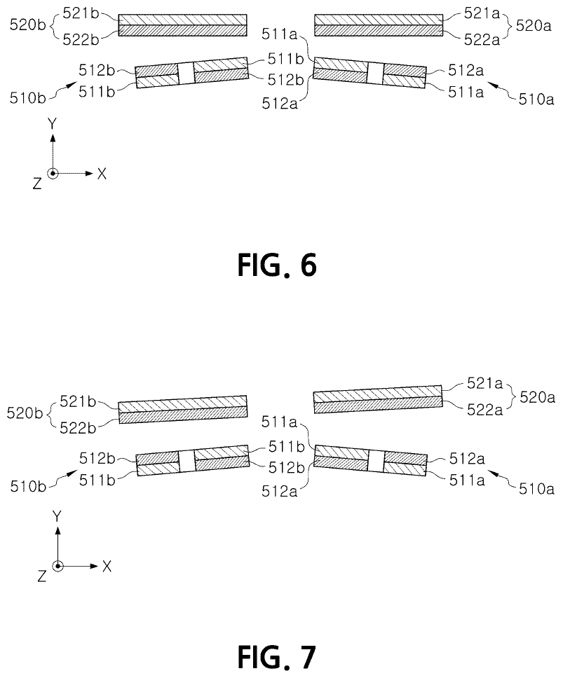

FIGS. 6 and 7 are views illustrating attractive and repulsive forces acting between first and second magnetic portions.

Referring to FIGS. 6 and 7, both attractive and repulsive forces may act between a first magnetic portion 510 and a second magnetic portion 520. Furthermore, a magnitude of the attractive force between the first and second magnetic portions 510 and 520 may be greater than a magnitude of the repulsive force between the first and second magnetic portions 510 and 520.

Therefore, a first ball member B1 may maintain contact with a guide member 320 and a housing 100, respectively, due to the attractive force between the first and second magnetic portions 510 and 520. Two ends of the second magnetic portion 520 in a first axis (X-axis) direction may be shaped to extend further in the first axis (X-axis) direction than two ends of the first magnetic portion 510 in the first axis (X-axis) direction.

For example, a length between the two ends of the second magnetic portion 520, which may be a movable member, in the first axis (X-axis) direction may be longer than a length between the two ends of the first magnetic portion 510, which may be a fixed member, in the first axis (X-axis) direction.

Both of the attractive and repulsive forces may occur between the first magnetic portion 510 and the second magnetic portion 520. In this case, a region in which the attractive force is generated may be a central region among portions in which the first magnetic portion 510 and the second magnetic portion 520 face each other, and a region in which the repulsive force is generated may be an outer side region in the first axis (X-axis) direction, among the portions in which the first magnetic portion 510 and the second magnetic portion 520 face each other.

The first magnetic portion 510 may include a plurality of magnets spaced apart in the first axis (X-axis) direction. In an embodiment, the first magnetic portion 510 may include a first magnet 510a and a second magnet 510b. The first magnet 510a and the second magnet 510b may be spaced apart in the first axis (X-axis) direction.

The second magnetic portion 520 may include a plurality of magnets spaced apart in the first axis (X-axis) direction. In an embodiment, the second magnetic portion 520 may include a third magnet 520a and a fourth magnet 520b. The third magnet 520a and the fourth magnet 520b may be spaced apart in the first axis (X-axis) direction.

The first magnet 510a may face the third magnet 520a, and the second magnet 510b may face the fourth magnet 520b.

The number of polarities on one surface of the first magnet 510a may be different from the number of polarities on one surface of the third magnet 520a. For example, one surface of the first magnet 510a (e.g., a surface facing the third magnet 520a) may be configured to have a plurality of polarities. Furthermore, one surface of the third magnet 520a (e.g., a surface facing the first magnet 510a) may be configured to have a single polarity.

The number of polarities on one surface of the second magnet 510b may be different from the number of polarities on one surface of the fourth magnet 520b. For example, one surface of the second magnet 510b (e.g., a surface facing the fourth magnet 520b) may be configured to have a plurality of polarities. Furthermore, one surface of the fourth magnet 520b (e.g., a surface facing the second magnet 510b) may be configured to have a single polarity.

The first magnet 510a and the second magnet 510b may be configured to have a plurality of polarities on one surface of each thereof.

For example, the one surface of the first magnet 510a may be configured to have a first polarity 511a, a neutral region, and a second polarity 512a in the first axis (X-axis) direction. The first polarity 511a may be an N-pole or an S-pole, and the second polarity 512a may be an opposite polarity to the first polarity 511a.

On the one surface of the first magnet 510a, a length of the first polarity 511a in the first axis (X-axis) direction may be different from a length of the second polarity 512a in the first axis (X-axis) direction. For example, a length of a polarity formed closer to the first ball member B1 (or a second optical axis (Z-axis)) in the first axis (X-axis) direction may be formed to be longer.

On the one surface of the first magnet 510a, an area of the first polarity 511a may be different from an area of the second polarity 512a. For example, an area of a polarity formed closer to the first ball member B1 (or the second optical axis (Z-axis)) may be formed to be larger.

The other surface of the first magnet 510a may have a polarity, opposite to a polarity of the one surface of the first magnet 510a.

Lengths or areas of the first polarity 511a and the second polarity 512a may be measured by applying liquid iron to the one surface of the first magnet 510a. For example, lengths or areas of the first polarity 511a and the second polarity 512a may be measured through a region to which liquid iron adheres.

The one surface of the second magnet 510b may be configured to have a first polarity 511b, a neutral region, and a second polarity 512b in the first axis (X-axis) direction.

On the one surface of the second magnet 510b, a length of the first polarity 511b in the first axis (X-axis) direction may be different from a length of the second polarity 512b in the first axis (X-axis) direction. For example, a length of a polarity formed closer to the first ball member B1 (or the second optical axis (Z-axis)) in the first axis (X-axis) direction may be formed to be longer.

On the one surface of the second magnet 510b, an area of the first polarity 511b may be different from an area of the second polarity 512b. For example, an area of a polarity formed closer to the first ball member B1 (or the second optical axis (Z-axis)) may be formed to be larger.

The other surface of the second magnet 510b may have a polarity, opposite to a polarity of the one surface of the second magnet 510b.

The first magnet 510a and the third magnet 520a may face each other in a first optical axis (Y-axis) direction, and the second magnet 510b and the fourth magnet 520b may face each other in the first optical axis (Y-axis) direction.

In addition, the third magnet 520a and the fourth magnet 520b may be configured such that one surface of each thereof has a single polarity.

For example, the number of polarities on the one surface of the first magnet 510a and the number of polarities on the one surface of the third magnet 520a, facing each other, may be configured differently. Furthermore, the number of polarities on the one surface of the second magnet 510b and the number of polarities on the one surface of the fourth magnet 520b, facing each other, may be configured differently.

For example, the one surface of the third magnet 520a and the one surface of the fourth magnet 520b may be configured to have a first polarity or a second polarity, respectively. In addition, a polarity of the one surface of the third magnet 520a may be the same as a polarity of the one surface of the fourth magnet 520b.

In an embodiment, a polarity of the one surface of the third magnet 520a may be opposite to a polarity of one surface of the first magnet 510a located closer to the first ball member B1 (or the second optical axis (Z-axis)). For example, when the first polarity 511a is located closer to the first ball member B1 than the second polarity 512a, on one surface of the first magnet 510a, the one surface of the third magnet 520a may have a second polarity 522a, and the other surface of the third magnet 520a may have a first polarity 521a.

In addition, a polarity of the one surface of the fourth magnet 520b may be opposite to a polarity of one surface of the second magnet 510b located closer to the first ball member B1. For example, when the first polarity 511b is located closer to the first ball member B1 than the second polarity 512b, on one surface of the second magnet 510b, the one surface of the fourth magnet 520b may have a second polarity 522b, and the other surface of the fourth magnet 520b may have a first polarity 521b.

Therefore, an attractive force may be generated in a region relatively close to the first ball member B1, and a repulsive force may be generated in a region relatively far from the first ball member B1.

When a distance between the first magnetic portion 510 and the second magnetic portion 520 relatively decreases due to rotation of the holder 330, a repulsive force between the first magnetic portion 510 and the second magnetic portion 520 may increase, allowing the holder 330 to return to an original position thereof without power being applied to the reflection module 300.

In this case, the original position may refer to a state in which the holder 330 is not rotated, for example, a state in which the first magnetic portion 510 and the second magnetic portion 520 are parallel.

For example, a reflection module 300 according to an embodiment of the present disclosure may reduce power consumption for positioning the holder 330 by mechanically implementing a centering structure of the holder 330.

Therefore, when shake correction is not required (e.g., when power is not supplied to the reflection module 300, or the like), a position of the holder 330 may be adjusted without separate power consumption.

An inclined surface 102 may be formed on an upper surface of a protrusion 101 of the housing 100. For example, surfaces extending in the first axis (X-axis) direction, based on a surface in which a first guide groove g1 is formed, may be inclined surfaces 102.

In an embodiment, the inclined surface 102 may slope downward in the first axis (X-axis) direction, based on the surface in which the first guide groove g1 is formed.

The first magnet 510a and the second magnet 510b of the first magnetic portion 510 may be disposed on the inclined surface 102 of the protrusion 101, respectively.

In an embodiment, a distance between the first magnet 510a and the third magnet 520a may be changed in the first axis (X-axis) direction. Furthermore, a distance between the second magnet 510b and the fourth magnet 520b may be also changed in the first axis (X-axis) direction.

For example, a distance between the first magnet 510a and the third magnet 520a may increase in the positive first axis (X-axis) direction (+X-axis direction). A distance between the second magnet 510b and the fourth magnet 520b may increase in the negative first axis (X-axis) direction (−X-axis direction) (see FIG. 6).

In an embodiment, a distance between the first magnet 510a and the third magnet 520a in a region in which the same polarities face may be formed to be greater than a distance between the first magnet 510a and the third magnet 520a in a region in which polarities different from each other face.

A distance between the second magnet 510b and the fourth magnet 520b in a region in which the same polarities face may be formed to be greater than a distance between the second magnet 510b and the fourth magnet 520b in a region in which polarities different from each other face.

For example, a separation distance between the first magnetic portion 510 and the second magnetic portion 520 in a region in which an attractive force acts may be smaller than a separation distance between the first magnetic portion 510 and the second magnetic portion 520 in a region in which a repulsive force acts.

The repulsive force acting between the first magnetic portion 510 and the second magnetic portion 520 enables position adjustment of the holder 330 in a state in which power is not applied, but may act as a driving load in a state in which power is applied for shake correction.

In the present embodiment, since a distance between the first magnetic portion 510 and the second magnetic portion 520 may be formed to be large in a region in which a repulsive force acts, influence of a driving load may be minimized when the guide member 320 rotates around the second optical axis (Z-axis).

When the holder 330 rotates around the first axis (X-axis) as a rotational axis, a direction of a driving force of one pair of magnet and coil may be the same as a direction of a driving force of the other pair of magnet and coil.

For example, when a direction of a driving force of one pair of magnet and coil is in the positive first optical axis (Y-axis) direction (+Y-axis direction), and a direction of a driving force of the other pair of magnet and coil is also in the positive first optical axis (Y-axis) direction (+Y-axis direction), the holder 330 may rotate around the first axis (X-axis).

In addition, when a direction of a driving force of one pair of magnet and coil is in the negative first optical axis (Y-axis) direction (31 Y-axis direction), and a direction of a driving force of the other pair of magnet and coil is also in the negative first optical axis (Y-axis) direction (−Y-axis direction), the holder 330 may rotate around the first axis (X-axis).

In addition, the holder 330 may be also rotated in a diagonal direction. For example, the holder 330 may rotate in a diagonal direction by rotating the holder 330 with respect to the second optical axis (Z-axis) and rotating the holder 330 with respect to the first axis (X-axis).

In an embodiment, the holder 330 may rotate in a diagonal direction by generating a driving force only from the one pair of magnet and coil, not from the other pair of magnet and coil. Alternatively, the holder 330 may rotate in a diagonal direction by generating a magnitude (and/or direction) of a driving force of the one pair of magnet and coil and a magnitude (and/or direction) of a driving force of the other pair of magnet and coil differently.

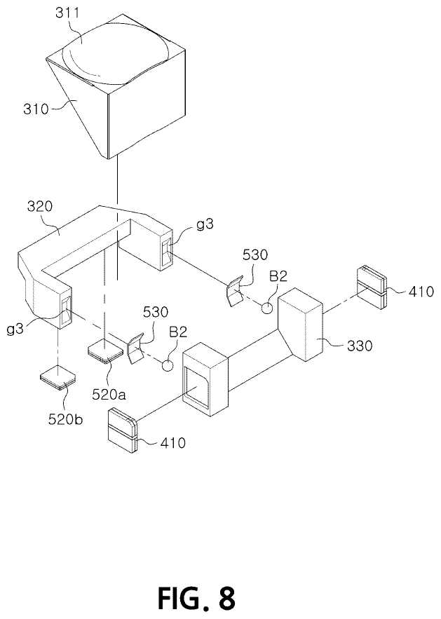

FIG. 8 is an exploded perspective view of a reflection module, and FIG. 9 is a view illustrating a positional relationship between a first driver, a first ball member, and a second ball member.

A second ball member B2 may be disposed between a guide member 320 and a holder 330. The second ball member B2 may be disposed between the guide member 320 and the holder 330 to form a rotational axis of the holder 330.

The second ball member B2 may include a plurality of balls spaced apart along a first axis (X-axis). A virtual line v2 connecting the plurality of balls of the second ball member B2 in a first axis (X-axis) direction may be spaced apart from the first driving magnet 410 in a second optical axis (Z-axis) direction (see FIG. 9).

In an embodiment, a first driving magnet 410 and a first coil 420 may be spaced apart from the second ball member B2 in the second optical axis (Z-axis) direction. When a driving force is generated in a first optical axis (Y-axis) direction by the first driving magnet 410 and the first coil 420, the holder 330 may rotate around the rotational axis formed by the second ball member B2.

The virtual line connecting the plurality of balls of the second ball member B2 in the first axis (X-axis) direction may pass through a reflective surface of a reflection member 310.

In an embodiment, when viewed in the first axis (X-axis) direction, a line extending a first optical axis (Y-axis) of a first lens module 311 may be located between both ends of the plurality of balls of the second ball member B2. In this case, the both ends of the plurality of balls of the second ball member B2 may refer to both ends in the second optical axis (Z-axis) direction.

A third guide groove g3 and a fourth guide groove g4 may be disposed on surfaces in which the guide member 320 and the holder 330 face each other (for example, surfaces facing each other in the second optical axis (Z-axis) direction). For example, the third guide groove g3 may be disposed in the guide member 320, and the fourth guide groove g4 may be disposed in the holder 330. The third guide groove g3 and the fourth guide groove g4 may face each other in the second optical axis (Z-axis) direction.

The third guide groove g3 may include a plurality of grooves spaced apart in the first axis (X-axis) direction, and the fourth guide groove g4 may include a plurality of grooves spaced apart in the first axis (X-axis) direction.

The second ball member B2 may be disposed between the third guide groove g3 and the fourth guide groove g4 to form the rotational axis of the holder 330.

An attractive force may be applied between the guide member 320 and the holder 330. For example, the holder 330 may be pulled toward the guide member 320, thereby allowing the second ball member B2 to maintain contact with the guide member 320 and the holder 330, respectively.

In an embodiment, a pulling yoke 530 may be disposed on the guide member 320.

The pulling yoke 530 may be disposed to face the first driving magnet 410. For example, at least a portion of the pulling yoke 530 may face the first driving magnet 410 in the second optical axis (Z-axis) direction.

The pulling yoke 530 may be formed of a magnetic material. Therefore, an attractive force may act between the first driving magnet 410 and the pulling yoke 530 in the second optical axis (Z-axis) direction.

Due to the attractive force between the first driving magnet 410 and the pulling yoke 530, the holder 330 may be pulled toward the guide member 320.

In the present embodiment, by arranging the pulling yoke 530 at a position facing the first driving magnet 410, a pulling force may be provided to the holder 330 even without a separate pulling magnet.

In an embodiment, the pulling yoke 530 may be disposed in the third guide groove g3 of the guide member 320. For example, the pulling yoke 530 may be mounted in the third guide groove g3 to form a bottom surface of the third guide groove g3. For example, the pulling yoke 530 may be located in the third guide groove g3 to form a contact surface with the second ball member B2. Therefore, the second ball member B2 may be in contact with the pulling yoke 530.

Since the second ball member B2 comes into contact with the pulling yoke 530, damage to the third guide groove g3 may be prevented even in occurrence of an impact or the like.

In an embodiment, the pulling yoke 530 may be integrally formed with the guide member 320 by insert injection molding. Therefore, the pulling yoke 530 may be embedded in the guide member 320 such that a surface of the pulling yoke 530 may be exposed to an outside of the guide member 320.

A camera module may sense a position of the reflection member 310. For example, since the reflection member 310 may be mounted on the holder 330, the position of the reflection member 310 may be detected by sensing a position of the holder 330.

The camera module may include a first position sensor 430. The first position sensor 430 may be located at a position capable of detecting a position of the first driving magnet 410 (e.g., a position at which a magnetic field of the first driving magnet 410 may pass through the first position sensor 430). In an embodiment, the first position sensor 430 may be located inside the first coil 420 or outside the first coil 420.

Referring to FIG. 9, the first position sensor 430 is illustrated as being disposed inside the first coil 420, but is not limited thereto, and the first position sensor 430 may also be disposed outside the first coil 420.

In an embodiment, the first position sensor 430 may include a first sub-position sensor 431 and a second sub-position sensor 432. The first sub-position sensor 431 and the second sub-position sensor 432 may be disposed spaced apart from each other in the first axis (X-axis) direction.

The first sub-position sensor 431 may be configured to detect a position of one of two magnets of the first driving magnet 410, and the second sub-position sensor 432 may be configured to detect a position of the other one of the two magnets of the first driving magnet 410.

The first sub-position sensor 431 and the second sub-position sensor 432 may be Hall sensors, respectively.

In an embodiment, polarity magnetization patterns of the two magnets of the first driving magnet 410 may be identical. For example, the two magnets of the first driving magnet 410 may have an S-pole, a neutral region, and an N-pole, respectively, on a surface facing the first coil 420 in a positive first optical axis (Y-axis) direction (+Y-axis direction).

Hereinafter, a method for sensing a position of the holder 330 when the polarity magnetization patterns of the two magnets of the first driving magnet 410 are identical will be described.

When the holder 330 rotates around a first axis (X-axis) as a rotational axis, both the first sub-position sensor 431 and the second sub-position sensor 432 may move away from or toward the same polarity. For example, by rotating the holder 330, both the first sub-position sensor 431 and the second sub-position sensor 432 may move away from the N-pole and may move closer to the S-pole, or away from the S-pole and may move closer to the N-pole. Therefore, signal values output from the first sub-position sensor 431 and signal values output from the second sub-position sensor 432 may have the same form.

When the holder 330 rotates around the first axis (X-axis) as the rotational axis, the signal values output from the first sub-position sensor 431 and the second sub-position sensor 432 may be summed to accurately sense a position of the holder 330.

When the holder 330 rotates around a second optical axis (Z-axis) as a rotational axis, the first sub-position sensor 431 moves closer to the N-pole and away from the S-pole, while the second sub-position sensor 432 may move closer to the S-pole and may move away from the N-pole. Therefore, signal values output from the first sub-position sensor 431 and signal values output from the second sub-position sensor 432 may have different forms.

For example, when signal values output from the first sub-position sensor 431 are in an upward-facing straight line form, signal values output from the second sub-position sensor 432 may be in a downward-facing straight line form. For example, a graph of the signal values output from the first sub-position sensor 431 and the second sub-position sensor 432 may have an X-shape, for example.

When the holder 330 rotates around the second optical axis (Z-axis) as the rotational axis, a difference operation may be performed on signal values output from the first sub-position sensor 431 and the second sub-position sensor 432 to accurately sense a position of the holder 330.

In an embodiment, the polarity magnetization patterns of the two magnets of the first driving magnet 410 may be different. For example, in one of the two magnets of the first driving magnet 410, a surface facing the first coil 420 may have an S-pole, a neutral region, and an N-pole in sequence in the positive first optical axis (Y-axis) direction (+Y-axis direction). And, in the other of the two magnets of the first driving magnet 410, a surface facing the first coil 420 may have an N-pole, a neutral region, and an S-pole in sequence in the positive first optical axis (Y-axis) direction (+Y-axis direction).

Hereinafter, a method for sensing a position of the holder 330 when the polarity magnetization forms of the two magnets of the first driving magnet 410 are different from each other will be described.

When the holder 330 rotates around the first axis (X-axis) as a rotational axis, the first sub-position sensor 431 may move closer to the N-pole and further away from the S-pole, while the second sub-position sensor 432 may move closer to the S-pole and further away from the N-pole. Therefore, signal values output from the first sub-position sensor 431 and signal values output from the second sub-position sensor 432 may have different forms.

For example, when the signal values output from the first sub-position sensor 431 are in an upward-facing straight line form, the signal values output from the second sub-position sensor 432 may be in a downward-facing straight line form.

Therefore, when the holder 330 rotates around the first axis (X-axis) as the rotational axis, a position of the holder 330 may be accurately detected by performing a difference operation on signal values output from the first sub-position sensor 431 and signal values output from the second sub-position sensor 432.

When the holder 330 rotates around the second optical axis (Z-axis) as the rotational axis, both the first sub-position sensor 431 and the second sub-position sensor 432 may move away from or toward the same polarity. For example, by rotating the holder 330, both the first sub-position sensor 431 and the second sub-position sensor 432 may move away from the N-pole and closer to the S-pole, or both the first sub-position sensor 431 and the second sub-position sensor 432 may move away from the S-pole and closer to the N-pole.

Therefore, the signal values output from the first sub-position sensor 431 and the signal values output from the second sub-position sensor 432 may have the same form. Therefore, when the holder 330 rotates around the second optical axis (Z-axis) as the rotational axis, a sum operation may be performed on signal values output from the first sub-position sensor 431 and the second sub-position sensor 432 to accurately sense a position of the holder 330.

Referring to FIG. 2, the second lens module 200 may be disposed between the reflection module 300 and the image sensor 800.

The camera module may include a second driver to move the second lens module 200 in the second optical axis (Z-axis) direction.

The second driver may include a second driving magnet 610 and a second coil 620. The second driving magnet 610 and the second coil 620 may be disposed to face each other in a direction, perpendicular to the second optical axis (Z-axis) direction.

The second driving magnet 610 may be mounted on the second lens module 200. For example, the second driving magnet 610 may be disposed on a side surface of the second lens module 200.

The second coil 620 may be disposed on the substrate 700, and the substrate 700 may be mounted on the housing 100 such that the second driving magnet 610 and the second coil 620 face each other in the first axis (X-axis) direction.

When power is applied to the second coil 620, the second lens module 200 may move in the second optical axis (Z-axis) direction by an electromagnetic force between the second driving magnet 610 and the second coil 620.

A third ball member may be disposed between the second lens module 200 and the housing 100, and the second lens module 200 may be guided by the third ball member to move in the second optical axis (Z-axis) direction. The third ball member may include a plurality of balls.

A reflection module and a camera module including the same, according to an embodiment of the present disclosure, may simplify structures thereof to reduce sizes and weights thereof.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflection module comprising:
a housing;
a guide member configured to be rotatable relative to the housing about a first rotational axis;
a holder configured to be rotatable about a second rotational axis, relative to the guide member and having a reflection member mounted thereon;
a first driver comprising a first driving magnet disposed on the holder and a first coil facing the first driving magnet; and
a pulling yoke disposed on the guide member and facing the first driving magnet,
wherein the first driving magnet comprises two magnets, the two magnets being separately disposed on one side surface and another side surface of the holder, spaced apart in a direction of the second rotational axis.

2. The reflection module of claim 1, wherein directions in which the first driving magnet and the first coil face each other are perpendicular to directions in which the first driving magnet and the pulling yoke face each other.

3. The reflection module of claim 1, wherein the first driving magnet and the first coil face each other in the direction of the second rotational axis, and
wherein the first driving magnet and the pulling yoke face each other in a direction of the first rotational axis.

4. The reflection module of claim 1, further comprising a protrusion protruded in a direction, perpendicular to both the first and second rotational axes, disposed on the housing,
wherein a first ball member is disposed between the protrusion and the guide member.

5. The reflection module of claim 4, further comprising a first magnetic portion disposed on the protrusion, and a second magnetic portion facing the first magnetic portion disposed on the guide member,
wherein both attractive and repulsive forces are applied between the first magnetic portion and the second magnetic portion.

6. The reflection module of claim 5, wherein a region in which the attractive force acts is closer to the first ball member than a region in which the repulsive force acts.

7. The reflection module of claim 5, wherein the first magnetic portion comprises a first magnet and a second magnet, spaced apart in the direction of the second rotational axis,
wherein the second magnetic portion comprises a third magnet and a fourth magnet, spaced apart in the direction of the second rotational axis, and
wherein the first ball member is disposed between the first magnet and the second magnet and between the third magnet and the fourth magnet.

8. The reflection module of claim 7, wherein one surface of the first magnet and one surface of the third magnet face each other in the direction perpendicular to both the first and second rotational axes,
wherein one surface of the second magnet and one surface of the fourth magnet face each other in the direction perpendicular to both the first and second rotational axes,
wherein the number of polarities on the one surface of the first magnet is different from the number of polarities on the one surface of the third magnet, and
wherein the number of polarities on the one surface of the second magnet is different from the number of polarities on the one surface of the fourth magnet.

9. The reflection module of claim 7, wherein the protrusion comprises an inclined surface, wherein the inclined surface is formed to be inclined from a surface on which the first ball member is disposed, in the direction of the second rotational axis, and
wherein the first magnet and the second magnet are respectively disposed on the inclined surface.

10. The reflection module of claim 5, wherein a distance between the first magnetic portion and the second magnetic portion increases in a direction away from the first ball member.

11. The reflection module of claim 1, further comprising a second ball member disposed between the guide member and the holder,
wherein the second ball member comprises a plurality of balls spaced apart in the direction of the second rotational axis,
wherein a plurality of guide grooves into which the second ball members are disposed are formed in the guide member, and
wherein the pulling yoke is disposed in the plurality of guide grooves.

12. The reflection module of claim 11, wherein the second ball member is in contact with the pulling yoke.

13. The reflection module of claim 1, further comprising:
a first sub-position sensor configured to sense a position of one magnet among the two magnets; and
a second sub-position sensor configured to sense a position of another magnet among the two magnets.

14. The reflection module of claim 13, wherein polarity arrangement forms of the two magnets are identical,
wherein a position of the reflection member relative to rotation about the second rotational axis is detected by performing a sum operation on signal values output from the first sub-position sensor and the second sub-position sensor, and
wherein a position of the reflection member relative to rotation about the first rotational axis is detected by performing a difference operation on signal values output from the first sub-position sensor and the second sub-position sensor.

15. A camera module comprising:
the reflection module of claim 1; and
a case coupled to the housing and having an opening through which light passes,
wherein the reflection member has an incident surface on which the light is incident, and
wherein the incident surface has a convex shape.

16. The camera module of claim 15, further comprising a cover coupled to the opening,
wherein a through-hole is formed in the cover through which the light passes, and
wherein the through-hole has two straight sections and two curved sections.
